(19) United States
(12) Patent Application Publication
(10) Pub. No.: US 2011/0117007 A1
(43) Pub. Date: May 19, 2011

(54) METHOD FOR MAKING MFI-TYPE MOLECULAR SIEVES

(75) Inventor: Allen W. Burton, JR., Richmond, CA (US)

(73) Assignee: Chervon U.S.A. Inc.

(21) Appl. No.: 12/617,997

(22) Filed: Nov. 13, 2009

(51) Int. Cl. C01B 39/38

(52) U.S. Cl. 423/704

(57) ABSTRACT

MFI-type molecular sieves, including aluminosilicate ZSM-5, borosilicate-ZSM-5, and silicalite-1, having a small crystal size are prepared from a reaction mixture either in the presence or absence of an alkali/alkaline metal component. The small crystal forms of ZSM-5 thus prepared are useful, for example, as catalysts in various hydrocarbon conversion processes.

### FIELD OF THE INVENTION

The present invention is directed to MFI-type molecular sieves and methods for preparing MFI-type molecular sieves.

### BACKGROUND OF THE INVENTION

Molecular sieves are a commercially important class of crystalline materials having distinct crystal structures with ordered pore structures and characteristic X-ray diffraction patterns. Natural and synthetic crystalline molecular sieves are useful as catalysts and adsorbents. The adsorptive and catalytic properties of each molecular sieve are determined in part by the dimensions of its pores and cavities. Thus, the utility of a particular molecular sieve in a particular application depends at least partly on its crystal structure. Molecular sieves are especially useful in such applications as gas separation and hydrocarbon conversion processes.

Molecular sieves identified by the International Zeolite Associate (IZA) as having the structure code MFI are known. ZSM-5 is a known crystalline MFI material, and is useful in many processes, including various catalytic reactions, such as catalytic cracking, alkylation, isomerization, and polymerization reactions. Accordingly, there is a continued need for new methods for making ZSM-5, particularly small crystal forms of this material.

### SUMMARY OF THE INVENTION

The present invention is directed to small crystal forms of aluminosilicate ZSM-5 (Al-ZSM-5), borosilicate ZSM-5 (B-ZSM-5), and silicalite-1.

In one embodiment, an aluminosilicate MFI-type molecular sieve prepared by:

(a) forming a reaction mixture containing: (1) at least one source of silicon oxide; (2) at least one source of boron oxide or aluminum oxide; (3) at least one source of an element selected from Groups 1 and 2 of the Periodic Table; (4) hydroxide ions; (5) a nitrogen-containing structure directing agent; and (6) water; and

(b) maintaining the reaction mixture under conditions sufficient to form crystals of the molecular sieve.

In another embodiment, an MFI-type molecular sieve may be prepared by:

(a) forming a reaction mixture that is substantially in the absence of elements from Groups 1 and 2 of the Periodic Table and contains: (1) at least one source of silicon oxide; (2) optionally, at least one source of aluminum oxide; (3) hydroxide ions; (4) a nitrogen-containing structure directing agent; and (5) water; and

(b) maintaining the reaction mixture under conditions sufficient to form crystals of the molecular sieve.

In another embodiment, a silicalite-1 molecular sieve is prepared by:

(a) forming an reaction mixture that is substantially free of elements from Group 1 and 2 of the Periodic Table, the reaction mixture containing: (1) at least one source of silicon oxide; (2) hydroxide ions; (3) a nitrogen-containing structure directing agent; and (4) water; and

(b) maintaining the reaction mixture under conditions sufficient to form crystals of the molecular sieve.

### BRIEF DESCRIPTION OF THE DRAWINGS

FIGS. 1a and 1b shows scanning electron micrographs of nanocrystalline aluminosilicate ZSM-5 prepared according to Example 1 of the instant invention, at a magnification of 50K and 250K, respectively;

FIGS. 2a and 2b shows scanning electron micrographs of nanocrystalline borosilicate ZSM-5 prepared according to Example 4 of the instant invention, at a magnification of 100K and 200K, respectively;

FIG. 3 is a powder X-ray diffraction pattern of small crystal silicalite-1 prepared in alkali/alkaline-free medium according to Example 6 of the present invention; and

FIG. 4 is a scanning electron micrograph of the small crystal silicalite-1 prepared in alkali/alkaline-free medium according to Example 6 of the present invention.

### DETAILED DESCRIPTION OF THE INVENTION

The present invention provides MFI-type molecular sieve compositions of exceptionally small crystal size, and methods for the facile preparation of the same. According to one aspect of the present invention, small crystal forms of the molecular sieves may be prepared from a reaction mixture that is at least substantially free of both an alkali metal component and an alkaline earth metal component. According to another aspect of the present invention, the small crystal molecular sieves may be prepared from a reaction mixture containing an alkali metal component.

### INTRODUCTION

The terms “source” and “active source” mean a reagent or precursor material capable of supplying at least one element in a form that can react and which may be incorporated into a molecular sieve structure. The terms “source” and “active source” as used herein exclude elements unintentionally present as contaminants or impurities in one or more reagents that are intentionally included in a reaction mixture.

The term “Periodic Table” refers to the version of IUPAC Periodic Table of the Elements dated Jun. 22, 2007, and the numbering scheme for the Periodic Table Groups is as described in Chemical and Engineering News, 63(5), 27 (1985).

Where permitted, all publications, patents and patent applications cited in this application are herein incorporated by reference in their entirety to the extent such disclosure is not inconsistent with the present invention.

Unless otherwise specified, the recitation of a genus of elements, materials or other components, from which an individual component or mixture of components can be selected, is intended to include all possible sub-generic combinations of the listed components and mixtures thereof. Also, the term “include” and its variants are intended to be non-limiting, such that recitation of items in a list is not to the exclusion of other like items that may also be useful in the materials, compositions, and methods of this invention.

### Synthesis in an Alkali/Alkaline-Containing Media

According to one embodiment of the present invention, a MFI-type molecular sieve of the present invention is synthesized by contacting, under crystallization conditions, (1) at least one source of silicon oxide; (2) at least one source of boron oxide or aluminum oxide; (3) at least one source of an element selected from Groups 1 and 2 of the Periodic Table; (4) hydroxide ions; and (5) a nitrogen-containing structure directing agent.

In general, the MFI-type molecular sieve may be prepared by:

(a) forming a reaction mixture containing: (1) at least one source of silicon oxide; (2) at least one source of boron oxide or aluminum oxide; (3) at least one source of an element selected from Groups 1 and 2 of the Periodic Table; (4) hydroxide ions; (5) a nitrogen-containing structure directing agent; and (6) water; and

(b) maintaining the reaction mixture under conditions sufficient to form crystals of the molecular sieve.

The composition of the reaction mixture from which an aluminosilicate ZSM-5 (Al-ZSM-5) molecular sieve is formed, in terms of molar ratios, is identified in Table 1 below:

TABLE 1

| Reactants | Broad | Preferred |
|---|---|---|
| SiO₂/Al₂O₃ | 15-225 | 20-100 |
| Q/SiO₂ | 0.02-1 | 0.1-0.5 |
| M/SiO₂ | 0.01-1 | 0.01-0.05 |
| OH⁻/SiO₂ | 0.05-1 | 0.1-0.5 |
| H₂O/SiO₂ | 5-10 | 5.5-7.5 |

wherein M is selected from elements from Group 1 or 2 of the Periodic Table, and Q is the nitrogen-containing structure directing agent.

The composition of the reaction mixture from which a borosilicate ZSM-5 (B-ZSM-5) molecular sieve is formed, in terms of molar ratios, is identified in Table 2 below:

TABLE 2

| Reactants | Broad | Preferred |
|---|---|---|
| SiO₂/B₂O₃ | 10-225 | 20-100 |
| Q/SiO₂ | 0.02-1 | 0.1-0.5 |
| M/SiO₂ | 0.01-1 | 0.01-0.05 |
| OH⁻/SiO₂ | 0.05-1 | 0.1-0.5 |
| H₂O/SiO₂ | 5-15 | 5.5-7.5 |

wherein M is selected from elements from Group 1 or 2 of the Periodic Table, and Q is the nitrogen-containing structure directing agent.

Al-ZSM-5 molecular sieve prepared as described above has a composition, as-synthesized and in the anhydrous state, in terms of mole ratios, as shown in Table 3:

TABLE 3

| | |
|---|---|
| SiO₂/Al₂O₃ | 15-225 |
| Q/SiO₂ | 0.03-0.05 |
| M/SiO₂ | 0.01-0.2 |

wherein Q and M are as described hereinabove.

In one subembodiment, the Al-ZSM-5 material prepared as described has a SiO₂/Al₂O₃ mole ratio in the range from 17 to 60.

The Al-ZSM-5 molecular sieve typically crystallizes as polycrystalline aggregates having first, second, and third dimensions which are each 200 nm or less. In a subembodiment, each of the first, second, and third dimensions of the aggregates is in the range from 100 nm to about nm. As determined by particle size analysis, 90% of the volume of the molecular sieve is present in aggregates that are less than 300 nm in size. Each crystalline aggregate of the molecular sieve contains a plurality of substantially uniform spheroidal crystallites. The crystallites each have a diameter typically in the range from about 20 nm to about 40 nm, and usually from 20 nm to 30 nm.

B-ZSM-5 prepared as described herein above has a composition, as-synthesized and in the anhydrous state, in terms of mole ratios, as shown in Table 4, wherein Q and M are as described hereinabove.

TABLE 4

| | |
|---|---|
| SiO₂/B₂O₃ | 20-225 |
| Q/SiO₂ | 0.03-0.05 |
| M/SiO₂ | 0.01-0.2 |

B-ZSM-5 of the present invention typically crystallizes as polycrystalline spheroidal aggregates having first, second, and third dimensions each of which is 100 nm or less. In a subembodiment, each of the first, second, and third dimensions of the aggregates of crystalline B-ZSM-5 of the present invention is in the range from 50 nm to 100 nm. Each crystalline aggregate of B-ZSM-5 contains a plurality of spheroidal crystallites. The crystallites each have a diameter typically in the range from 20 nm to 30 nm. In one embodiment, the crystallites each have a diameter of less than 25 nm.

### Synthesis in an Alkali/Alkaline-Free Media

According to one embodiment of the present invention, a MFI-type molecular sieve of the present invention is synthesized by contacting, under crystallization conditions and substantially in the absence of elements from Groups 1 and 2 of the Periodic Table, (1) at least one source of silicon oxide; (2) optionally, at least one source of aluminum oxide; (3) hydroxide ions; and (4) a nitrogen-containing structure directing agent.

In general, the MFI-type molecular sieve may be prepared by:

(a) forming a reaction mixture that is substantially in the absence of elements from Groups 1 and 2 of the Periodic Table and contains: (1) at least one source of silicon oxide; (2) optionally, at least one source of aluminum oxide; (3) hydroxide ions; (4) a nitrogen-containing structure directing agent; and (5) water; and

(b) maintaining the reaction mixture under conditions sufficient to form crystals of the molecular sieve.

In one embodiment, a silicalite-1 molecular sieve is synthesized by contacting, under crystallization conditions and substantially in the absence of elements from Groups 1 and 2 of the Periodic Table, (1) at least one source of silicon oxide; (2) hydroxide ions; and (3) a nitrogen-containing structure directing agent.

In general, the silicalite-1 of the present invention is prepared by:

(a) forming an reaction mixture that is substantially free of elements from Group 1 and 2 of the Periodic Table, the reaction mixture containing: (1) at least one source of silicon oxide; (2) hydroxide ions; (3) a nitrogen-containing structure directing agent; and (4) water; and

(b) maintaining the reaction mixture under conditions sufficient to form crystals of the molecular sieve.

In this embodiment, the reaction mixture is characterized as having an external liquid phase during crystallization of the molecular sieve. Synthesis of silicalite-1 according to the present invention is not dependent on the presence of an organic polymer in the reaction mixture; and reaction mixtures of the present invention will generally be free of any such organic polymer component.

The composition of the reaction mixture from which the silicalite-1 molecular sieve is formed in this embodiment, in terms of molar ratios, is identified in Table 5 below:

TABLE 5

| Reactants | Broad | Preferred |
|---|---|---|
| Q/SiO₂ | 0.05-1 | 0.1-0.5 |
| OH⁻/SiO₂ | 0.05-1 | 0.1-0.5 |
| H₂O/SiO₂ | >5-20 | >5-<15 |

wherein Q is the nitrogen-containing structure directing agent.

According to another embodiment of the present invention, an Al-ZSM-5 molecular sieve is synthesized by contacting, under crystallization conditions and substantially in the absence of elements from Groups 1 and 2 of the Periodic Table, (1) at least one source of silicon oxide; (2) at least one source of aluminum oxide; (3) hydroxide ions; and (4) a nitrogen-containing structure directing agent.

In general, the aluminosilicate ZSM-5 is prepared by:

(a) forming an reaction mixture that is substantially free of elements from Group 1 and 2 of the Periodic Table, the reaction mixture containing: (1) at least one source of silicon oxide; (2) at least one source of aluminum oxide; (3) hydroxide ions; (4) a nitrogen-containing structure directing agent; and (5) water; and

(b) maintaining the reaction mixture under conditions sufficient to form crystals of the molecular sieve.

Such a reaction mixture will typically include an external liquid phase prior to and/or during crystallization of the molecular sieve, and the reaction mixture will be free of an organic polymer component.

The composition of the reaction mixture from which the aluminosilicate ZSM-5 molecular sieve is formed in this embodiment, in terms of molar ratios, is identified in Table 6 below:

TABLE 6

| Reactants | Broad | Preferred |
|---|---|---|
| SiO₂/Al₂O₃ | 20-225 | 50-150 |
| Q/SiO₂ | 0.1-1 | 0.1-0.5 |
| OH⁻/SiO₂ | 0.1-1 | 0.1-0.5 |
| H₂O/SiO₂ | >5-20 | >5-<15 |

wherein Q is a cation of a structure directing agent.

The terms “alkali/alkaline-free,” “substantially free of elements from Group 1 and 2 of the Periodic Table,” and “substantially in the absence of elements from Groups 1 and 2 of the Periodic Table” as used herein, are synonymous and mean elements from Group 1 and 2 are completely absent from the reaction mixture or are present in quantities that have less than a measurable effect on, or confer less than a material advantage to, the synthesis of the molecular sieves described herein (e.g. Na⁺ is present as an impurity of one or more of the reactants). A reaction mixture substantially free of alkali metal ions will typically contain, for example, a M/T molar ratio of between 0 and less than 0.02 (0≦M/T<0.02), wherein M represents elements from Group 1 and 2 of the Periodic Table, and T=Si+Al for Al-ZSM-5 and T=Si for silicalite-1. In one subembodiment, 0≦M/T≦0.01.

Typically, when synthesizing silicalite-1, the reaction mixture is maintained at an elevated temperature for a period of not more than 15 days, and usually for a period in the range from about two (2) to five (5) days

The silicalite-1 and other MFI-type molecular sieves that are synthesized from alkali/alkaline-free media according to an aspect of the present invention will generally have a combined content of alkali metal and alkaline earth metal of not more than about 1000 ppm by weight, typically not more than about 700 ppm by weight, and usually not more than about 500 ppm by weight.

The silicalite-1 of the present invention typically crystallizes from the reaction mixture as polycrystalline aggregates having first, second, and third dimensions, each of which is in the range from 50 nm to 250 nm, and typically in the range from 100 to 200 nm. Each crystalline aggregate of silicalite-1 comprises a plurality of crystallites. The crystallites in turn have first, second, and third dimensions, each of which is 20 nm or less.

Al-ZSM-5 prepared in an alkali/alkaline-free media has a composition, as-synthesized and in the anhydrous state, as shown in Table 7, in terms of mole ratios, wherein Q is a structure directing agent

TABLE 7

| | |
|---|---|
| SiO₂/Al₂O₃ | 15-225 |
| Q/SiO₂ | 0.03-0.05 |

The aluminosilicate ZSM-5 synthesized according to the present invention will typically crystallize as polycrystalline aggregates. Each of a first, second, and third dimension of each aggregate is typically 200 nm or less. In one embodiment, the aggregates each comprise a plurality of crystallites, and each of a first, second, and third dimension of the crystallites is 20 nm or less. In another embodiment, the crystallites have first, second, and third dimensions in the range from 20 to 40 nm.

It will be understood by a person skilled in the art that the Al-ZSM-5 described herein may contain one or more trace impurities, as described hereinabove with reference to silicalite-1. The Al-ZSM-5 of the invention may also or alternatively contain trace amounts of an alkali metal or alkaline earth metal. The Al-ZSM-5 of the invention will generally have a combined content of alkali metal and alkaline earth metal of not more than about 1000 ppm by weight, typically not more than about 700 ppm by weight, and usually not more than about 500 ppm by weight.

### Reactants and Synthesis Conditions

Sources of silicon oxide useful herein may include fumed silica, precipitated silicates, silica hydrogel, silicic acid, colloidal silica, tetra-alkyl orthosilicates (e.g. tetraethyl orthosilicate), and silica hydroxides.

Sources of aluminum oxide useful in the present invention include aluminates, alumina, and aluminum compounds such as AlCl₃, Al₂SO₄, Al(OH)₃, kaolin clays, and other molecular sieves.

Sources of boron oxide useful in the present invention include borosilicate glasses, alkali borates, boric acid, borate esters, and certain molecular sieves. Non-limiting examples of a source of boron oxide include sodium tetraborate decahydrate and boron beta molecular sieve.

A source of element M may comprise any M-containing compound which is not detrimental to the crystallization process. M-containing compounds may include oxides, hydroxides, nitrates, sulfates, halides, oxalates, citrates and acetates thereof. In one subembodiment, the element from Group 1 or 2 of the Periodic Table is sodium (Na) or potassium (K). In a subembodiment, an M-containing compound is an alkali metal halide, such as a bromide or iodide of potassium.

The molecular sieve reaction mixture can be supplied by more than one source. Also, two or more reaction components can be provided by one source. As an example, borosilicate molecular sieves may be synthesized from boron-containing beta molecular sieves, as taught in U.S. Pat. No. 5,972,204, issued Oct. 26, 1999 to Corma et al.

The structure directing agent is an organic nitrogen containing compound, such as a primary, secondary, or tertiary amine or a quaternary ammonium compound, suitable for synthesizing MFI-type materials. Structure directing agents suitable for synthesizing ZSM-5 are known in the art. (see, for example, Handbook of Molecular Sieves, Szostak, Van Nostrand Reinhold, 1992). Exemplary structure directing agents include tetrapropylammonium hydroxide, tetraethylammonium hydroxide, tripropylamine, diethylamine, 1,6-diaminohexane, 1-aminobutane, 2,2′-diaminodiethylamine, N-ethylpyridinium, ethanolamine and diethanolamine.

The reaction mixture can be prepared either batch-wise or continuously. Crystal size, crystal morphology, and crystallization time of the molecular sieve may vary with the nature of the reaction mixture and the crystallization conditions.

According to one aspect of the present invention, the reaction mixture lacks a mineral acid component; and according to another aspect of the invention, the reaction mixture further lacks a seed crystal component. For example, in an embodiment of the present invention, the reaction mixture is at least substantially free of sulfuric acid; and in another embodiment, the reaction mixture is further at least substantially free of a seed crystal component.

The structure directing agent is typically associated with anions which may be any anion that is not detrimental to the formation of the molecular sieve. Representative anions include chloride, bromide, iodide, hydroxide, acetate, sulfate, tetrafluoroborate, carboxylate, and the like.

In practice, the MFI-type molecular sieve is prepared by: (a) preparing a reaction mixture as described hereinabove; and (b) maintaining the reaction mixture under crystallization conditions sufficient to form crystals of the molecular sieve. The reaction mixture is maintained at an elevated temperature until crystals of the molecular sieve are formed. The hydrothermal crystallization of the molecular sieve is usually conducted under pressure, and usually in an autoclave so that the reaction mixture is subject to autogenous pressure, typically at a temperature from about 85° C. to about 200° C., usually from about 100° C. to about 180° C., and often from about 120° C. to about 170° C.

The reaction mixture may be subjected to mild stirring or agitation during the crystallization step, or the reaction mixture can be heated statically. During the crystallization step, crystals of the MFI material can be allowed to nucleate spontaneously from the reaction mixture. The use or addition of seed crystals as a component of the reaction mixture is not a requirement of the present invention.

It will be understood by a person skilled in the art that the MFI material described herein may contain one or more trace impurities, such as amorphous materials, phases having framework topologies which do not coincide with the molecular sieve, and/or other impurities (e.g., organic hydrocarbons).

Once the molecular sieve crystals have formed, the solid product may be separated from the reaction mixture by mechanical separation techniques such as filtration. The crystals are water washed and then dried to obtain “as-synthesized” molecular sieve crystals. The drying step can be performed at atmospheric pressure or under vacuum.

MFI material is used as-synthesized, but typically the molecular sieve will be thermally treated (calcined). The term “as-synthesized” refers to the molecular sieve in its form after crystallization, for example, prior to removal of the structure directing agent cation and/or element M. The structure directing agent material can be removed by thermal treatment (e.g., calcination), preferably in an oxidative atmosphere (e.g., air, or another gas with an oxygen partial pressure greater than 0 kPa), at a temperature (readily determinable by one skilled in the art) sufficient to remove the structure directing agent from the molecular sieve. The structure directing agent can also be removed by photolysis techniques, substantially as described in U.S. Pat. No. 6,960,327 to Navrotsky and Parikh.

Usually, it may also be desirable to remove any alkali metal cations from the molecular sieve by ion-exchange and to replace any such alkali metal cations with hydrogen, ammonium, or a desired metal ion. The ZSM-5 can be combined with various metals, such as a metal selected from Groups 8-10 of the Periodic Table.

Following ion exchange, the molecular sieve is typically washed with water and dried at temperatures ranging from 90° C. to about 120° C. After washing, the molecular sieve can be calcined in air, steam, or inert gas at a temperature ranging from about 315° C. to about 650° C. ° C. for periods ranging from about 1 to about 24 hours, or more, to produce a catalytically active product useful, e.g., in various catalytic hydrocarbon conversion reactions.

MFI-type products synthesized by the methods described herein are characterized by their powder X-ray diffraction (XRD) pattern. The powder XRD patterns and data presented herein were collected by standard techniques. The radiation was CuK-α radiation. The peak heights and the positions, as a function of 2θ where θ is the Bragg angle, were read from the relative intensities of the peaks, and d, the interplanar spacing in Angstroms corresponding to the recorded lines, calculated. The powder XRD data for MFI-type molecular sieves prepared herein is known (see, for example, Collection of Simulated XRD Powder Patterns for Molecular Sieves, Fifth Edition 2007, M. M. J. Treacy & J. B. Higgins, Elsevier).

### Catalyst Compositions Comprising Small Crystal MFI-Type Molecular Sieves

According to one aspect of the invention, MFI-type molecular sieves synthesized as described herein, either from alkali-containing or alkali/alkaline-free media, may be used in the preparation of catalyst compositions. Catalyst compositions comprising MFI-type molecular sieves of the present invention may have a composition, in terms of weight percent, as shown in Table 8:

TABLE 8

| Component | Broad | Preferred |
|---|---|---|
| MFI-type molecular sieve | 1-99% | 15-50% |
| binder | 1-99% | 50-85% |
| Group 8-10 metals(s) and | 0-10% | 0.5-5% |
| other elements | | |

What is described herein with reference to post-synthesis treatment(s), catalyst compositing, and/or applications regarding a particular molecular sieve product of the present invention may similarly apply, without limitation, to other molecular sieve products of this invention. For commercial applications as a catalyst, the molecular sieves synthesized according to the present invention may be formed into a suitable size and shape. This forming can be done by techniques such as pelletizing, extruding, and combinations thereof. In the case of forming by extrusion, extruded materials may promote diffusion and access of feed materials to interior surfaces of the molecular sieve. The molecular sieve crystals can also be composited with binders resistant to the temperatures and other conditions employed in hydrocarbon conversion processes. Binders may also be added to improve the crush strength of the catalyst.

The binder material may comprise one or more refractory oxides, which may be crystalline or amorphous, or can be in the form of gelatinous precipitates, colloids, sols, or gels. Forming pellets or extrudates from molecular sieves, including the small crystal forms of the molecular sieve, generally involves using extrusion aids and viscosity modifiers in addition to binders. These additives are typically organic compounds such as cellulose based materials, for example, METHOCEL cellulose ether (Dow Chemical Co.), ethylene glycol, and stearic acid. Such compounds are known in the art. It is important that these additives do not leave a detrimental residue, i.e., one with undesirable reactivity or one that can block pores of the molecular sieve, after pelletizing. The relative proportions of the molecular sieve and binder can vary widely. Generally, the molecular sieve content ranges from about 1 to about 99 weight percent (wt %) of the dry composite, usually in the range of from about 5 to about 95 wt % of the dry composite, and more typically from about 50 to about 85 wt % of the dry composite.

The catalyst can optionally contain one or more metals selected from Groups 8-10 of the Periodic Table. In one subembodiment, the catalyst contains a metal selected from the group consisting of Pt, Pd, Ni, Rh, Ir, Ru, Os, and mixtures thereof. In another subembodiment, the catalyst contains palladium (Pd) or platinum (Pt). For each embodiment described herein, the Group 8-10 metal content of the catalyst may be generally in the range of from 0 to about 10 wt %, typically from about 0.05 to about 5 wt %, usually from about 0.1 to about 3 wt %, and often from about 0.3 to about 1.5 wt %.

Additionally, other elements may be used in combination with the metal selected from Groups 8-10 of the Periodic Table. Examples of such “other elements” include Sn, Re, and W. Examples of combinations of elements that may be used in catalyst materials of the present invention include, without limitation, Pt/Sn, Pt/Pd, Pt/Ni, and Pt/Re. These metals or other elements can be readily introduced into the composite using one or more of various conventional techniques, including ion exchange, pore-fill impregnation, or incipient wetness impregnation. Reference to the catalytically active metal or metals is intended to encompass such metal or metals in the elemental state or in some form such as an oxide, sulfide, halide, carboxylate, and the like.

### Applications of Small Crystal MFI-Type Molecular Sieves

Molecular sieves prepared according to the novel methods described herein may be useful in various catalytic hydrocarbon conversion processes, such as xylene isomerization, aromatic alkylation, and conversion of methanol to gasoline. Al-ZSM-5 of the invention may also be useful as a fluid catalytic cracking (FCC) upgrade additive and as a support for rheniforming catalyst. In such processes, the small crystallite size of compositions of the present invention may offer a competitive advantage over conventional materials, e.g., where higher external surface area is desired or mass transfer limitations are critical.

The hydrocarbonaceous feed can be contacted with the catalyst in a fixed bed system, a moving bed system, a fluidized system, a batch system, or combinations thereof. Either a fixed bed system or a moving bed system is preferred. In a fixed bed system, the feed is passed into at least one reactor that contains a fixed bed of the catalyst prepared from the MFI-type molecular sieves of the invention. The flow of the feed can be upward, downward or radial. Interstage cooling can be performed, for example, by injection of cool hydrogen between reactor beds. The reactors can be equipped with instrumentation to monitor and control temperatures, pressures, and flow rates that are typically used in hydroconversion processes. Multiple beds may also be used in conjunction with compositions of the invention, wherein two or more beds may each contain a different catalytic composition, at least one of which may comprise a small crystal MFI-type molecular sieve of the present invention.

### EXAMPLES

The following examples demonstrate but do not limit the present invention.

### Synthesis of Small-Crystal Aluminosilicate ZSM-5 (Examples 1-3)

### Example 1

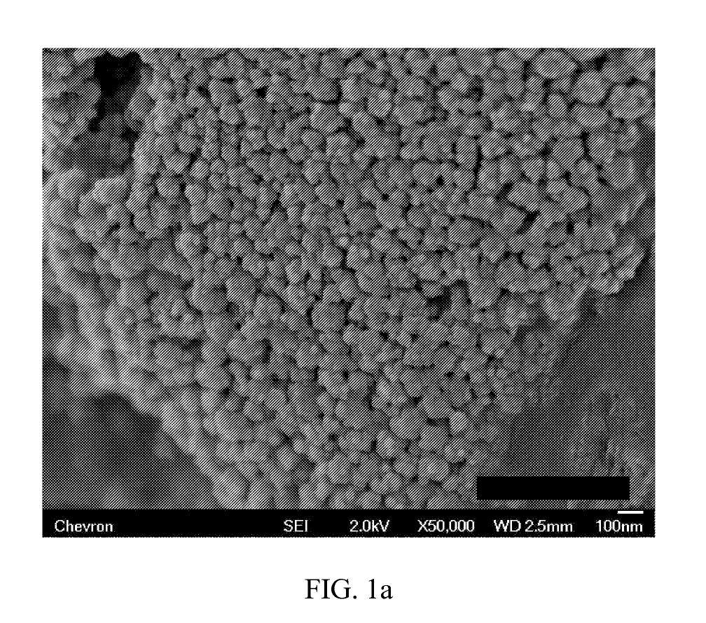

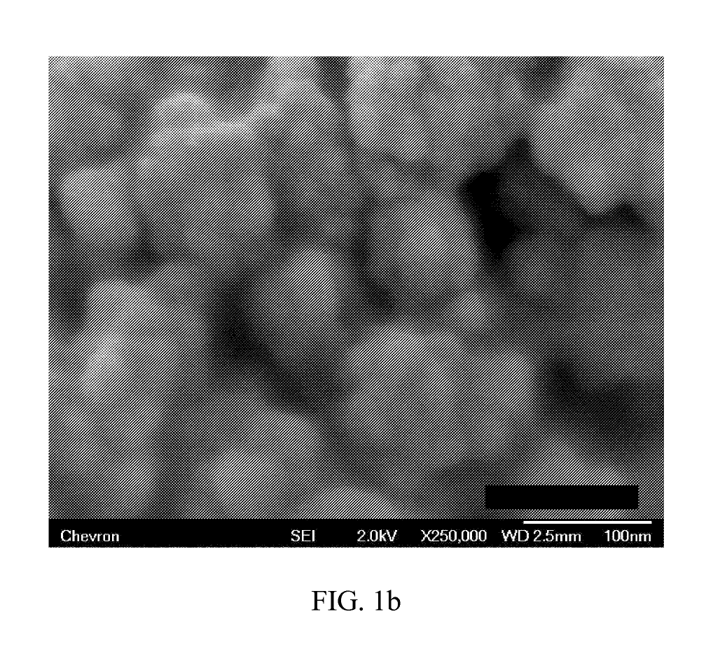

In a 23-mL Teflon liner, 0.06 g of sodium hydroxide was dissolved in 1.52 g of 40% TPAOH (40% aqueous solution) and 0.40 g of deionized water. 0.029 g of Reheis F-2000 aluminum hydroxide (Reheis, Inc., Berkeley Heights, N.J.) was then dissolved in the solution. 0.90 g of CAB-O-SIL® M-5 fumed silica (Cabot Corp. Boston, Mass.) was then mixed into the solution to create a uniform suspension. The liner was then capped and placed within a Parr Steel autoclave reactor. The autoclave was heated in a convection oven at a static temperature of 100° C. for 3 days. The autoclave was then removed and allowed to cool to room temperature. The gel solids were recovered by centrifugation, the aqueous phase was decanted, and the solids were then re-suspended and centrifuged again. This was repeated until the conductivity was <200 micromho/cm. The recovered solids were allowed to dry in an oven at 95° C. overnight. Powder XRD analysis identified the molecular sieve product as Al-ZSM-5. The SEM images of the product (FIG. 1) indicated that the polycrystalline aggregates were about 100 nm or less in size and most of the individual crystals were less than 40 nm in size.

### Example 2

In a 125-mL Teflon liner, 1.32 g of sodium hydroxide was dissolved in 33.44 g of 40% TPAOH (40% aqueous solution) and 8.80 g of deionized water. 0.48 g of Reheis F2000 aluminum hydroxide was then dissolved in the solution. 19.8 g of CAB-O-SIL® M-5 was then mixed into the solution to create a uniform gel (gel Si/Al˜66). (The gel required about 1 hour to mix by hand.) The liner was then capped and placed within a Parr Steel autoclave reactor. The autoclave was heated in a convection oven at a static temperature of 135° C. for 70 hours. The autoclave was then removed and allowed to cool to room temperature. The gel solids were recovered by centrifugation, the aqueous phase was decanted, and the solids were re-suspended and centrifuged again. This was repeated until the conductivity was <200 micromho/cm. The recovered solids were allowed to dry in an oven at 95° C. overnight. Powder XRD analysis confirmed the identity of the product as aluminosilicate ZSM-5. SEM analysis (not shown) indicated that the product crystallized as polycrystalline aggregates about 75 to 125 nm in size, with individual crystal grains that were 50 nm or less in size.

The product was calcined to 595° C. for 5 hours in 2% oxygen. The calcined molecular sieve was then twice exchanged in an aqueous solution of ammonium nitrate that possessed a mass of ammonium nitrate salt equal to the molecular sieve mass, and the mass of the water was 10 times that of the molecular sieve mass. After filtering, washing, and drying the molecular sieve, the molecular sieve was calcined to 495° C. for 5 hours. The micropore volume and external surface area of the molecular sieve were then measured by nitrogen physisorption. The measured micropore volume was 0.11 cc/g and the external surface area was 138 m²/g.

### Example 3

The procedure of Example 2 was repeated except the amount of Reheis F2000 aluminum hydroxide was decreased to provide a gel with a Si/Al ratio of ˜133. SEM analysis indicated that the Al-ZSM-5 product crystallized as spherical polycrystalline aggregates less than 100 nm in size. The measured micropore volume and external surface area (by nitrogen physisorption) were 0.11 cc/g and 95 m²/g.

### Example 4

### Synthesis of Small-Crystal Borosilicate ZSM-5

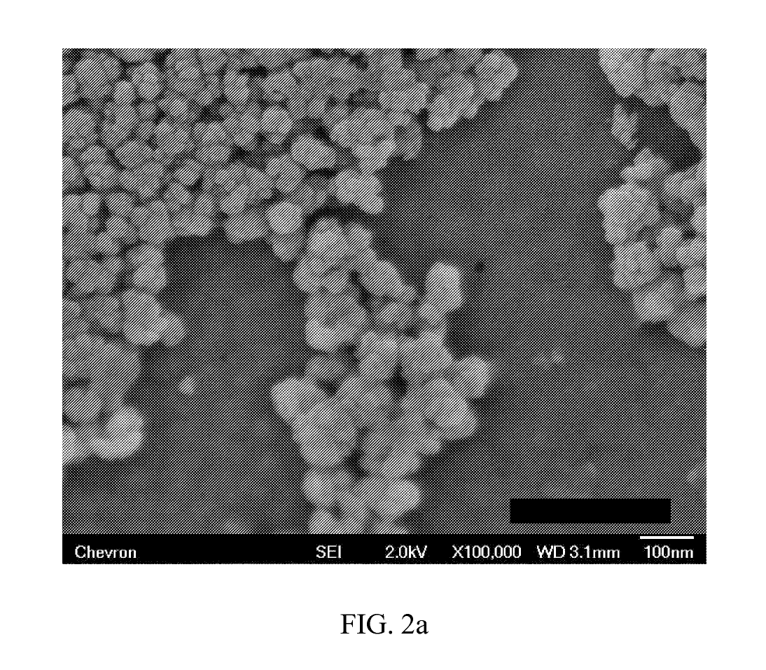

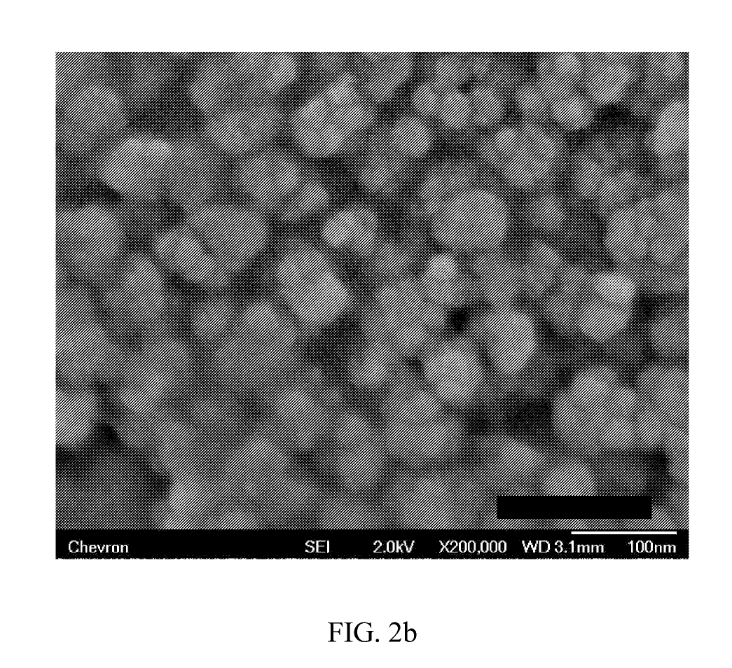

In a 23-mL Teflon liner, 0.18 g of sodium hydroxide was dissolved in 4.56 g of 40% TPAOH (40% aqueous solution) and 1.32 g of deionized water. 0.18 g of sodium tetraborate decahydrate was then dissolved in the solution. 2.70 g of CAB-O-SIL® M-5 was then mixed into the solution to create a uniform suspension. The liner was then capped and placed within a Parr Steel autoclave reactor. The autoclave was heated in a convection oven at a static temperature of 100° C. for 3 days. The autoclave was then removed and allowed to cool to room temperature. The gel solids were recovered by centrifugation, the aqueous phase was decanted, and the solids were then re-suspended and centrifuged again. This was repeated until the conductivity was <200 micromho/cm. The recovered solids were allowed to dry in an oven at 95° C. overnight. Powder XRD analysis identified the molecular sieve product as borosilicate ZSM-5. SEM images of the B-ZSM-5 product (FIG. 2) showed polycrystalline aggregates that were about 50 nm or less in size, with individual crystal grains that were 25 nm or less in size. The H₂O/SiO₂ mole ratio for the reaction mixture in this Example was about 5.1.

### Example 5

The procedure of Example 4 was repeated except 3.35 g of deionized water was added (instead of 1.32 g in Example 4) thereby increasing the H₂O/SiO₂ mole ratio for the reaction mixture of this Example 5 to about 7.5. SEM images (not shown) indicated that the crystalline aggregates of the product of this Example 5 were considerably larger (at about 100 nm) than those of Example 4.

### Example 6

### Synthesis of Small Crystal Silicalite-1 in Alkali/Alkaline-Free Medium

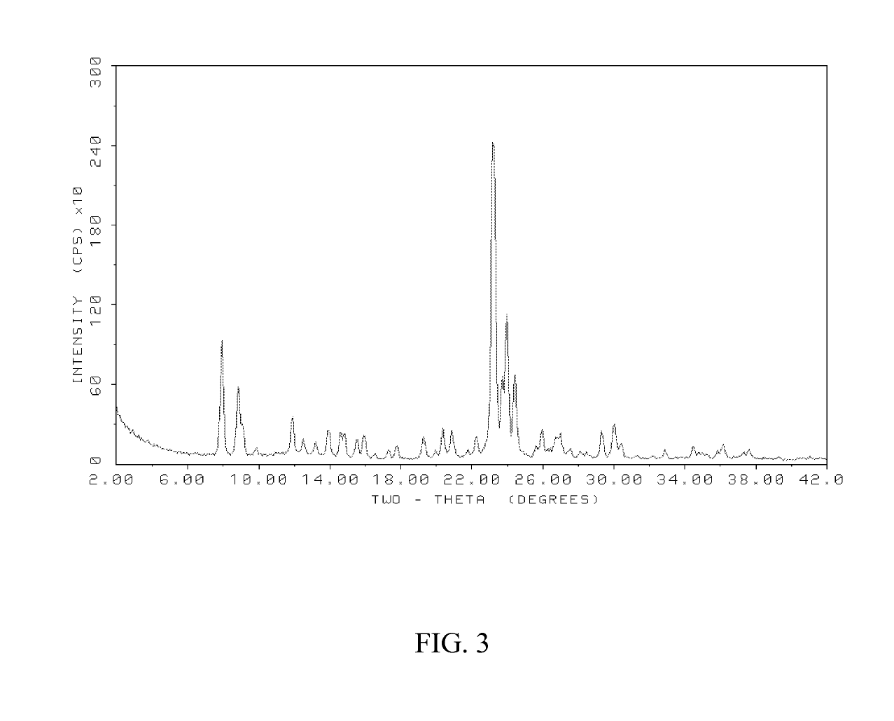

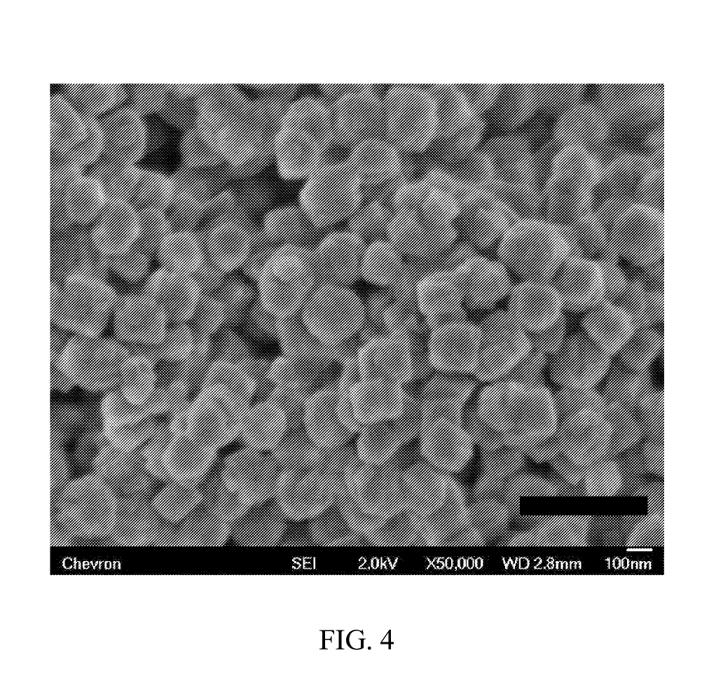

In a 23-mL Teflon liner, 1.52 g of 40% TPAOH (40% aqueous solution) was mixed with 0.40 g of deionized water. 0.90 g of CAB-O-SIL® M-5 was then mixed into the solution to create a uniform suspension. The liner was then capped and placed within a Parr Steel autoclave reactor. The autoclave was heated in a convection oven at a static temperature of 120° C. for 3 days. The autoclave was then removed and allowed to cool to room temperature. The gel solids were recovered by centrifugation, the aqueous phase was decanted, and the solids were then re-suspended and centrifuged again. This was repeated until the conductivity was <200 micromho/cm. The recovered solids were allowed to dry in an oven at 95° C. overnight. Powder XRD analysis (FIG. 3) identified the product as silicalite-1. SEM analysis (FIG. 4) indicated crystallization of the product as polycrystalline aggregates having dimensions in the range from about 100 nm to about 200 nm, and mostly only about 100 to 150 nm in size.

### Example 7

### Synthesis of Small Crystal Aluminosilicate ZSM-5 in Alkali/Alkaline-Free Medium

The procedure of Example 6 was repeated except 0.040 g of Reheis F2000 aluminum hydroxide was dissolved into the TPAOH solution before the addition of the CAB-O-SIL® M-5. Powder XRD analysis identified the product as aluminosilicate ZSM-5. SEM analysis (not shown) indicated that the Al-ZSM-5 product of this Example crystallized as polycrystalline aggregates that were somewhat larger than the product of Example 6.

What is claimed is:

1. An aluminosilicate ZSM-5 molecular sieve comprising substantially uniform spheroidal crystallites having a diameter in the range from 20 nm to 40 nm, the molecular sieve made by a process comprising:
(a) forming a reaction mixture containing: (1) at least one source of silicon oxide, (2) at least one source of aluminum oxide, (3) at least one source of an element selected from Groups 1 and 2 of the Periodic Table, (4) hydroxide ions, (5) a nitrogen-containing structure directing agent, and (6) water, and
(b) maintaining the reaction mixture under conditions sufficient to form crystals of the molecular sieve;
wherein the reaction mixture comprises, in terms of molar ratios, the following:

| | |
|---|---|
| SiO₂/Al₂O₃ | 15-225 |
| Q/SiO₂ | 0.02-1 |
| M/SiO₂ | 0.01-1 |
| OH⁻/SiO₂ | 0.05-1 |
| H₂O/SiO₂ | 5-10 |

wherein M is the element selected from Group 1 or 2 of the Periodic Table, and Q is the nitrogen-containing structure directing agent.

2. The method according to claim 1, wherein the spheroidal crystallites have a diameter in the range from about 20 nm to about 30 nm.

3. The method according to claim 1, wherein the aluminosilicate ZSM-5 is crystallized as polycrystalline aggregates, each of the aggregates comprising a plurality of the spheroidal crystallites.

4. The method according to claim 3, wherein each of the aggregates has a first, second, and third dimension, and each of the first, second, and third dimensions is less than about 200 nm.

5. The method according to claim 1, wherein the molecular sieve product comprises aluminosilicate ZSM-5 having a SiO₂/Al₂O₃ mole ratio in the range from about 17 to about 60.

6. A borosilicate ZSM-5 molecular sieve comprising substantially uniform spheroidal crystallites having a diameter in the range from 20 nm to 30 nm, the molecular sieve made by a process comprising:
(a) forming a reaction mixture containing (1) at least one source of silicon oxide, (2) at least one source of boron oxide or aluminum oxide, (3) at least one source of an element selected from Groups 1 and 2 of the Periodic Table, (4) hydroxide ions, (5) a nitrogen-containing structure directing agent, and (6) water, and
(b) maintaining the reaction mixture under conditions sufficient to form crystals of the molecular sieve;
wherein the reaction mixture comprises, in terms of molar ratios, the following:

| | |
|---|---|
| SiO₂/B₂O₃ | 10-225 |
| Q/SiO₂ | 0.02-1 |
| M/SiO₂ | 0.01-1 |
| OH⁻/SiO₂ | 0.05-1 |
| H₂O/SiO₂ | 5-15 |

wherein M is the element selected from Group 1 or 2 of the Periodic Table, and Q is the nitrogen-containing structure directing agent.

7. The method according to claim 6, wherein the spheroidal crystallites have a diameter of 25 nm or less.

8. The method according to claim 6, wherein the borosilicate ZSM-5 is crystallized as polycrystalline aggregates, each of the aggregates comprising a plurality of the spheroidal crystallites.

9. The method according to claim 8, wherein each of the aggregates has a first, second, and third dimension, and each of the first, second, and third dimensions is 200 nm or less.

10. A silicalite-1 molecular sieve comprising substantially uniform spheroidal crystallites having a diameter of less than 20 nm, the molecular sieve made by a process comprising:
(a) forming an reaction mixture that is substantially free of elements from Group 1 and 2 of the Periodic Table, the reaction mixture containing: (1) at least one source of silicon oxide, (2) hydroxide ions, (3) a nitrogen-containing structure directing agent, and (4) water, and
(b) maintaining the reaction mixture under conditions sufficient to form crystals of the molecular sieve;
wherein the reaction mixture comprises, in terms of molar ratios, the following:

| | |
|---|---|
| Q/SiO₂ | 0.05-1 |
| OH⁻/SiO₂ | 0.05-1 |
| H₂O/SiO₂ | >5-20 |

wherein Q is the nitrogen-containing structure directing agent.

11. The method according to claim 10, wherein the silicalite-1 is crystallized as polycrystalline aggregates, each of the aggregates comprising a plurality of the spheroidal crystallites.

12. The method according to claim 11, wherein each of the aggregates has a first, second, and third dimension, and each of the first, second, and third dimensions is 50 nm to 250 nm.

13. An aluminosilicate ZSM-5 molecular sieve comprising substantially uniform spheroidal crystallites having a diameter of 20 nm to 40 nm, the molecular sieve made by a process comprising:
(a) forming an reaction mixture that is substantially free of elements from Group 1 and 2 of the Periodic Table, the reaction mixture containing: (1) at least one source of silicon oxide, (2) at least one source of aluminum oxide, (3) hydroxide ions, (4) a nitrogen-containing structure directing agent, and (5) water, and
(b) maintaining the reaction mixture under conditions sufficient to form crystals of the molecular sieve;
wherein the reaction mixture comprises, in terms of molar ratios, the following:

| | |
|---|---|
| SiO₂/Al₂O₃ | 20-225 |
| Q/SiO₂ | 0.1-1 |
| OH⁻/SiO₂ | 0.1-1 |
| H₂O/SiO₂ | >5-20 |

wherein Q is the nitrogen-containing structure directing agent.

14. The method according to claim 10, wherein the aluminosilicate ZSM-5 is crystallized as polycrystalline aggregates, each of the aggregates comprising a plurality of the spheroidal crystallites.

15. The method according to claim 11, wherein each of the aggregates has a first, second, and third dimension, and each of the first, second, and third dimensions is 200 nm or less.
